(19) United States
(12) Patent Application Publication
(10) Pub. No.: US 2013/0057598 A1
(43) Pub. Date: Mar. 7, 2013

(54) DISPLAY PANEL, DISPLAY DEVICE, AND METHOD OF DRIVING THE SAME

(71) Applicants: Akihisa Iwamoto, Osaka-shi (JP); Hideki Morii, Osaka-shi (JP); Takayuki Mizunaga, Osaka-shi (JP); Kei Ikuta, Osaka-shi (JP)

(72) Inventors: Akihisa Iwamoto, Osaka-shi (JP); Hideki Morii, Osaka-shi (JP); Takayuki Mizunaga, Osaka-shi (JP); Kei Ikuta, Osaka-shi (JP)

(21) Appl. No.: 13/698,094

(22) PCT Filed: Apr. 18, 2011
(86) PCT No.: PCT/JP2011/059527

§ 371 Date: Nov. 15, 2012

(30) Foreign Application Priority Data
Jun. 2, 2010 (JP) 2010-126894

(51) Int. Cl. G09G 5/10

(52) U.S. Cl. 345/690

(57) ABSTRACT

The present invention provides a display panel having decreased cost and current consumption by decreasing the number of data signal lines from the conventional number, a display device including the display panel, and a method of driving the display device.

Each pixel formation portion (10) included in a display unit (200) of a display device is configured to arrange three sub-pixel formation portions (1r, 1g, 1b) for forming sub-pixels of mutually different color components in a data signal line extension direction. Each one data signal line (30) is arranged between a sub-pixel formation portion vertical string (3) in an odd-order from a front of a scanning signal line extension direction and a sub-pixel formation portion vertical string (3) adjacent to the sub-pixel formation portion vertical string (3) at the back of the scanning signal line extension direction. Sub-pixel formation portion vertical strings (3, 3) positioned at both sides of each data signal line (30) are connected to the data signal line. Each one scanning signal line (40) is arranged at both sides of a sub-pixel formation portion in a data signal line extension direction. Mutually adjacent sub-pixel formation portion vertical strings (3, 3) are connected to mutually different scanning signal line (40).

### TECHNICAL FIELD

The present invention relates to an active matrix-type display panel, a display device including the same, and a method of driving the same.

### BACKGROUND ART

In general, a display unit of a display panel in an active matrix-type display device is configured by a pixel formation portion laid out in a matrix form. This pixel formation portion has a plurality of sub-pixel formation portions. For example, in an active matrix-type display device that displays a color image based on three primary colors of R (red), G (green), and B (blue), one pixel formation portion is conventionally configured by arrangement of three sub-pixel formation portions for forming three sub-pixels of R, G, and B in a direction in which scanning signal lines extend. FIG. 18 is a pattern diagram showing an electrical configuration of relevant portions of this conventional active matrix-type display device. This display device includes a display unit 200, a data signal line drive circuit 130, and a scanning signal line drive circuit 140. In the display unit 200, there are formed a plurality of data signal lines 30 and a plurality of scanning signal lines 40 that cross the plurality of data signal lines 30, and there are laid out pixel formation portions 10 including three sub-pixel formation portions for forming three sub-pixels of R, G, and B in a matrix form along the plurality of data signal lines and the plurality of scanning signal lines. The plurality of data signal lines 30 are connected to the data signal line drive circuit 130, and the plurality of scanning signal lines 40 are connected to the scanning signal line drive circuit 140.

According to the conventional active matrix-type display device, 3×m data signal lines and n scanning signal lines are necessary, where m represents the number of pixel formation portions in a direction in which the scanning signal lines extend, and n represents the number of pixel formation portions in a direction in which the data signal lines extend. Hereinafter, a direction in which the scanning signal lines extend is called a “scanning signal line extension direction”, and a direction in which the data signal lines extend is called a “data signal line extension direction”. A direction in which the scanning signal lines are connected to the scanning signal line drive circuit is called a front of the scanning signal line extension direction, and a direction opposite to this direction is called a back of the scanning signal line extension direction. Similarly, a direction in which the data signal lines are directed to the data signal line drive circuit is called a front of the data signal line extension direction, and a direction opposite to this direction is called a back of the data signal line extension direction.

As shown in FIG. 18, in general, the active matrix-type display device includes the data signal drive circuit and the scanning signal line drive circuit. The data signal line drive circuit has a larger amount of circuits than that in the scanning signal line drive circuit. Therefore, cost of the data signal line drive circuit is higher than cost of the scanning signal line drive circuit. When the number of the data signal lines increases, the amount of circuits further increases. Consequently, the cost of the data signal line drive circuit becomes higher, and at the same time, current consumption increases. That is, when the number of data signal lines increases, cost and current consumption of the display device as a whole increase. Because the number of the data signal lines increases in proportion to the number of pixel formation portions, the above problem becomes serious when sizes of display devices are progressively increased in recent years.

To solve the above problem, there is known a display device that constitutes one pixel formation portion by arranging of sub-pixel formation portions in the order of R (red), G (green), and B (blue) in a data signal line extension direction (refer to Patent Document 1, for example). Further, there is known a display device in which sub-pixel formation portions adjacent in a scanning signal line extension direction share one data signal line (refer to Patent Document 2, for example). Further, there is known a display device in which two scanning signal line drive circuits are provided (refer to Patent Document 3, for example). According to these display devices, the number of data signal lines can be decreased from that in the above active matrix-type display device.

### PRIOR ART DOCUMENTS

### Patent Documents

[Patent Document 1] Japanese Patent Application Laid-Open Publication No. 2007-148240
[Patent Document 2] U.S. Pat. No. 5,151,689
[Patent Document 3] U.S. Pat. No. 7,385,576

### SUMMARY OF THE INVENTION

### Problems to be Solved by the Invention

However, according to the configurations of the display devices described in Patent Document 1 and Patent Document 2, the number of data signal lines can decrease to only m. Further, according to the configuration of the display device described in Patent Document 3, the number of data signal lines can decrease to only (3/2)×m. To further decrease the cost and current consumption of the display device, the number of data signal lines needs to be further decreased.

An object of the present invention is to provide an active matrix-type display panel of which cost and current consumption are decreased by decreasing number of data signal lines from conventional number, a display device including the display panel, and a method of driving the display device.

### Solution to the Problems

A first aspect of the present invention is directed to a display panel for displaying a color image based on a predetermined number of primary colors, the display panel comprising:

a plurality of data signal lines extending in a first direction;

a plurality of scanning signal lines extending in a second direction and crossing the plurality of data signal lines; and

a plurality of pixel formation portions arranged in a matrix form along the plurality of data signal lines and the plurality of scanning signal lines, wherein

each pixel formation portion is configured to arrange in the first direction a predetermined number of sub-pixel formation portions for forming sub-pixels that respectively express the predetermined number of primary colors,

each data signal line corresponds to one of a plurality of sets of sub-pixel formation portion strings obtained by dividing sub-pixel formation portions in the plurality of pixel formation portions into sets by using mutually adjacent two sub-pixel formation portion strings extending in the first direction as one set, is arranged between two sub-pixel formation portion strings constituting a corresponding set, and is connected to each sub-pixel formation portion included in the two sub-pixel formation portion strings,

each sub-pixel formation portion string extending in the second direction corresponds to one of a plurality of sets of scanning signal lines obtained by dividing the plurality of scanning signal lines into sets by using adjacent two scanning signal lines as one set, and is arranged between two scanning signal lines constituting a corresponding set, and

one of two scanning signal lines constituting each set of the plurality of sets of scanning signal lines is connected to one of two sub-pixel formation portions connected to the same data signal line of a sub-pixel formation portion included in a sub-pixel formation portion string corresponding to the set, and the other of the two scanning signal lines is connected to the other of the two sub-pixel formation portions.

A second aspect of the present invention is directed to the display panel according to the first aspect of the present invention, wherein

the color image is based on three primary colors, and

each pixel formation portion is configured to arrange in the first direction three sub-pixel formation portions for forming three sub-pixels that respectively correspond to the three primary colors.

A third aspect of the present invention is directed to a display device to display a color image based on the predetermined number of primary colors, the display device comprising:

a display panel according to the first or the second aspect of the present invention;

a data signal line drive circuit for applying a plurality of data signals to express the color image respectively to the plurality of data signal lines; and

a scanning signal line drive circuit for selectively activating the plurality of scanning signal lines, wherein

each sub-pixel formation portion takes in a data signal applied to a data signal line connected to the sub-pixel formation portion, when a scanning signal line connected to the sub-pixel formation portion is activated.

A fourth aspect of the present invention is directed to the display device according to the third aspect of the present invention, wherein

at least one of the data signal line drive circuit and the scanning signal line drive circuit is formed integrally with the plurality of pixel formation portions on the display panel.

A fifth aspect of the present invention is directed to the display device according to the third or the fourth aspect of the present invention, wherein

each sub-pixel formation portion includes:
a switching element to come into an on state or an off state depending on whether a scanning signal line connected to the sub-pixel formation portion is activated or not; and
a predetermined capacitance connected to the data signal line via the switching element,

the data signal line drive circuit sequentially applies a data signal to express a sub-pixel to be formed by a sub-pixel formation portion connected to each data signal line, to the data signal line, and

the scanning signal line drive circuit activates a scanning signal line connected to each sub-pixel formation portion during a main charge period as a period when the sub-pixel formation portion should take in a data signal expressing a sub-pixel to be formed by the sub-pixel formation portion, and activates the scanning signal line during a preliminary charge period as a predetermined period prior to and close to the main charge period.

A sixth aspect of the present invention is directed to the display device according to the third or the fourth aspect of the present invention, wherein

the data signal line drive circuit

inverts a polarity of a data signal taken into each sub-pixel formation portion in each one frame period, and

in one frame period, sets polarities of data signals taken into sub-pixel formation portions mutually adjacent in the second direction mutually the same, and inverts polarities of data signals taken into the sub-pixel formation portions in each predetermined number of sub-pixel formation portion strings extending in the second direction.

A seventh aspect of the present invention is directed to the display device according to the third or the fourth aspect of the present invention, wherein

the data signal line drive circuit

inverts a polarity of a data signal taken into each sub-pixel formation portion in each one frame period, and

in one frame period, mutually differentiates polarities of data signals taken into sub-pixel formation portions mutually adjacent in the first direction, and mutually differentiates polarities of data signals taken into the sub-pixel formation portions mutually adjacent in the second direction.

A eighth aspect of the present invention is directed to the display device according to the third or the fourth aspect of the present invention, wherein

the data signal line drive circuit

inverts a polarity of a data signal taken into each sub-pixel formation portion in each one frame period, and

in one frame period, sets polarities of data signals taken into sub-pixel formation portions mutually adjacent in the first direction mutually the same, and inverts polarities of data signals taken into the sub-pixel formation portions in each predetermined number of sub-pixel formation portion strings extending in the first direction.

A ninth aspect of the present invention is directed to the display device according to the eighth aspect of the present invention, wherein

the data signal line drive circuit

in one frame period, sets polarities of data signals taken into sub-pixel formation portions connected to the same data signal line mutually the same, and inverts polarities of data signals taken into the sub-pixel formation portions in each two sub-pixel formation portion strings corresponding to the same data signal line and extending in the first direction.

A tenth aspect of the present invention is directed to the display panel according to the first or the second aspect of the present invention, wherein

each sub-pixel formation portion includes a switching element to come into an on state or an off state depending on whether a scanning signal line connected to the sub-pixel formation portion is activated or not, and

the switching element is a thin-film transistor formed of amorphous silicon.

A eleventh aspect of the present invention is directed to the display panel according to the first or the second aspect of the present invention, wherein

each sub-pixel formation portion includes a switching element to come into an on state or an off state depending on whether a scanning signal line connected to the sub-pixel formation portion is activated or not, and

the switching element is a thin-film transistor formed of polysilicon.

A twelfth aspect of the present invention is directed to the display panel according to the first or the second aspect of the present invention, wherein

each sub-pixel formation portion includes a switching element to come into an on state or an off state depending on whether a scanning signal line connected to the sub-pixel formation portion is activated or not, and

the switching element is a thin-film transistor formed of microcrystalline silicon.

A thirteenth aspect of the present invention is directed to the display panel according to the first or the second aspect of the present invention, wherein

each sub-pixel formation portion includes a switching element to come into an on state or an off state depending on whether a scanning signal line connected to the sub-pixel formation portion is activated or not, and

the switching element is a thin-film transistor formed of indium gallium zinc oxide.

A fourteenth aspect of the present invention is directed to a method of driving a display device including a display panel including a plurality of data signal lines extending in a first direction, a plurality of scanning signal lines extending in a second direction and crossing the plurality of data signal lines, and a plurality of pixel formation portions arranged in a matrix form along the plurality of data signal lines and the plurality of scanning signal lines, and displaying a color image based on a predetermined number of primary colors, the method comprising:

a data signal line drive step of applying a plurality of data signals expressing the color image to the plurality of data signal lines respectively; and

a scanning signal line drive step of selectively activating the plurality of scanning signal lines, wherein

each pixel formation portion is configured to arrange in the first direction a predetermined number of sub-pixel formation portions for forming sub-pixels respectively expressing the predetermined number of primary colors,

each data signal line corresponds to one of a plurality of sets of sub-pixel formation portion strings obtained by dividing sub-pixel formation portions in the plurality of pixel formation portions into sets by using mutually adjacent two sub-pixel formation portion strings extending in the first direction as one set, is arranged between two sub-pixel formation portion strings constituting a corresponding set, and is connected to each sub-pixel formation portion included in the two sub-pixel formation portion strings,

each sub-pixel formation portion string extending in the second direction corresponds to one of a plurality of sets of scanning signal lines obtained by dividing the plurality of scanning signal lines into sets by using adjacent two scanning signal lines as one set, and is arranged between two scanning signal lines constituting a corresponding set,

one of two scanning signal lines constituting each set of the plurality of sets of scanning signal lines is connected to one of two sub-pixel formation portions that are connected to the same data signal line of sub-pixel formation portions included in a sub-pixel formation portion string corresponding to the set, and the other of the two scanning signal lines is connected to the other of the two sub-pixel formation portions, and

each sub-pixel formation portion takes in a data signal applied to a data signal line connected to the sub-pixel formation portion, when a scanning signal line connected to the sub-pixel formation portion is activated.

A fifteenth aspect of the present invention is directed to the method according to the fourteenth aspect of the present invention, wherein

in the scanning signal line drive step, the plurality of scanning signal lines are sequentially activated, and

in the data signal line drive step, data signals expressing sub-pixels to be formed by sub-pixel formation portions included in one of corresponding two sub-pixel formation portion strings and data signals expressing sub-pixels to be formed by sub-pixel formation portions included in the other of the corresponding two sub-pixel formation portion strings are alternately applied to each data signal line in conjunction with activation of the plurality of scanning signal lines.

### Advantages of the Invention

According to any one of the first aspect, the third aspect, the tenth to thirteenth aspects, and the fourteenth aspect of the present invention, the number of data signal lines becomes smaller than the number of pixel formation portions in the scanning signal line extension direction as the second direction. Accordingly, the amount of circuits in the data signal line drive circuit decreases, and therefore, cost and current consumption of the data signal line drive circuit can be decreased. Therefore, cost and current consumption of the display device as a whole can be decreased.

According to the second aspect of the present invention, each pixel formation portion is configured to arrange three sub-pixel formation portions for forming sub-pixels that respectively express different color components which constitute three primary colors, in the data signal line extension direction as the first direction. Accordingly, by employing this structure in a color image display based on the widely distributed three primary colors, an advantage similar to that of the first aspect of the present invention can be achieved while the cost of the display device is further decreased.

According to the fourth aspect of the present invention, at least one of the data signal line drive circuit and the scanning signal line drive circuit, and a plurality of pixel formation portions are integrally formed on the display panel. Accordingly, an advantage similar to that of the first aspect of the present invention can be achieved while picture-frame areas are decreased.

According to the fifth aspect of the present invention, before a predetermined capacitance in each sub-pixel formation portion is charged by a data signal that indicates a sub-pixel to be formed by the sub-pixel formation portion, the predetermined capacitance is preliminarily charged by a data signal that is near in time. A charge shortage due to an increase in the number of sub-pixel formation portions connected to one data signal line can be prevented, by this precharge operation in each sub-pixel formation portion. Therefore, an advantage similar to that of the first aspect of the present invention can be achieved while reduction of a display quality due to a charge shortage of the predetermined capacitance is suppressed.

According to the sixth aspect of the present invention, there is performed a line inversion of inverting polarities of data signals taken into sub-pixel formation portions in one frame period, in each predetermined number of sub-pixel formation portion strings extending in the scanning signal line extension direction as the second direction. Accordingly, in a display device that requires an inversion drive such as a liquid crystal display device, an advantage similar to that of the first aspect of the present invention can be achieved while degradation of a display quality is suppressed.

According to the seventh aspect of the present invention, there is performed a dot inversion of inverting polarities of data signals that are taken into sub-pixel formation portions in one frame period, in each one sub-pixel formation portion. Accordingly, in a display device that requires an inversion drive such as a liquid crystal display device, an advantage similar to that of the first aspect of the present invention can be achieved while degradation of a display quality is further suppressed.

According to the eighth aspect of the present invention, there is performed a column inversion of inverting polarities of data signals taken into sub-pixel formation portions in one frame period, in each predetermined number of sub-pixel formation portion strings extending in the data signal line extension direction as the first direction. Accordingly, in a display device that requires an inversion drive such as a liquid crystal display device, an advantage similar to that of the first aspect of the present invention can be achieved while degradation of a display quality is suppressed.

According to the ninth aspect of the present invention, there is performed a column inversion of inverting polarities of data signals taken into sub-pixel formation portions in one frame period, in each two sub-pixel formation portion strings extending in the data signal line extension direction as the first direction. Accordingly, in a display device that requires an inversion drive such as a liquid crystal display device, an advantage similar to that of the first aspect of the present invention can be obtained while suppressing degradation of a display quality. Further, because polarities of data signal lines that are taken into sub-pixel formation portions connected to the same data signal line in one frame period are mutually the same, a cycle of polarity inversion of a data signal becomes longer than that of another line inversion drive, and power consumption can be decreased.

### BRIEF DESCRIPTION OF THE DRAWINGS

FIG. 1 is a pattern diagram showing an electrical configuration of a liquid crystal display device according to a first embodiment of the present invention.

FIG. 2 is a pattern diagram showing another example of an arrangement of a thin-film transistor in the first embodiment.

FIG. 3 is a circuit diagram showing equivalent circuits of sub-pixel formation portions in the first embodiment.

FIG. 4 is a timing chart showing an operation in the first embodiment.

FIG. 5 is a schematic diagram showing a configuration on a liquid crystal panel in the first embodiment.

FIG. 6 is a schematic diagram showing another example of a configuration on a liquid crystal panel in the first embodiment.

FIG. 7 is a schematic diagram showing still another example of a configuration on a liquid crystal panel in the first embodiment.

FIG. 8 is a schematic diagram showing yet another example of a configuration on a liquid crystal panel in the first embodiment.

FIG. 9(A) to FIG. 9(C) are schematic diagrams showing an inversion drive in the first embodiment.

FIG. 10 is a timing chart showing the inversion drive in the first embodiment.

FIG. 11(A) to FIG. 11(C) are schematic diagrams showing an inversion drive in a first modification of the first embodiment.

FIG. 12 is a timing chart showing the inversion drive in the first modification of the first embodiment.

FIG. 13(A) to FIG. 13(C) are schematic diagrams showing an inversion drive in a second modification of the first embodiment.

FIG. 14 is a timing chart showing the inversion drive in the second modification of the first embodiment.

FIG. 15(A) to FIG. 15(C) are schematic diagrams showing an inversion drive in a second embodiment of the present invention.

FIG. 16 is a timing chart for describing a precharge operation in the second embodiment.

FIG. 17 is a timing chart for describing a precharge operation in a modification of the second embodiment.

FIG. 18 is a pattern diagram showing an electrical configuration of a conventional display device.

### MODES FOR CARRYING OUT THE INVENTION

Embodiments of the present invention will be described below with reference to the accompanying drawings.

### 1. First Embodiment

### 1.1 Entire Configuration

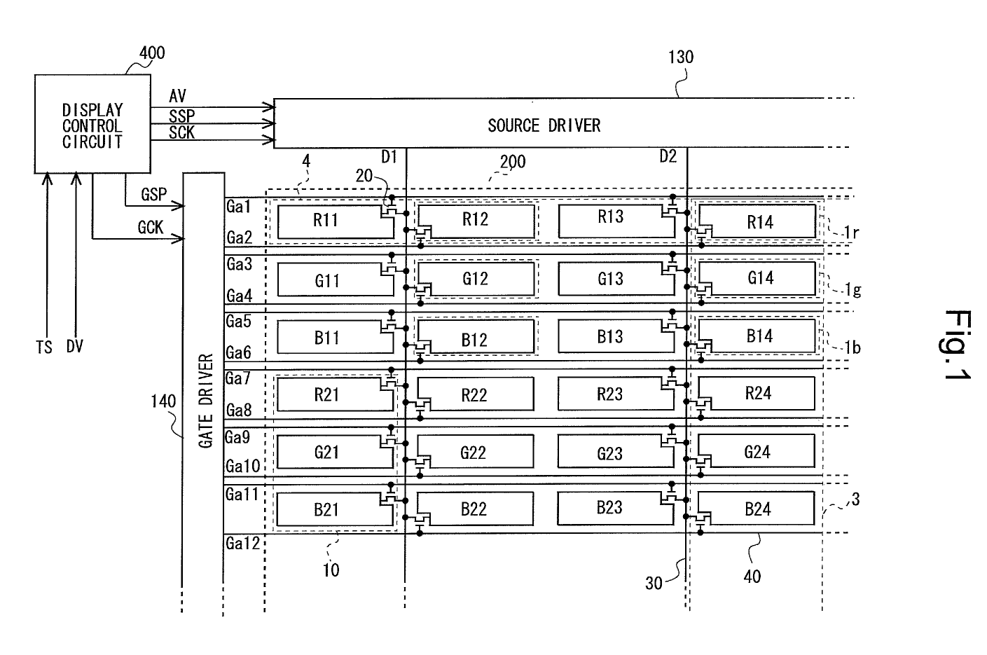

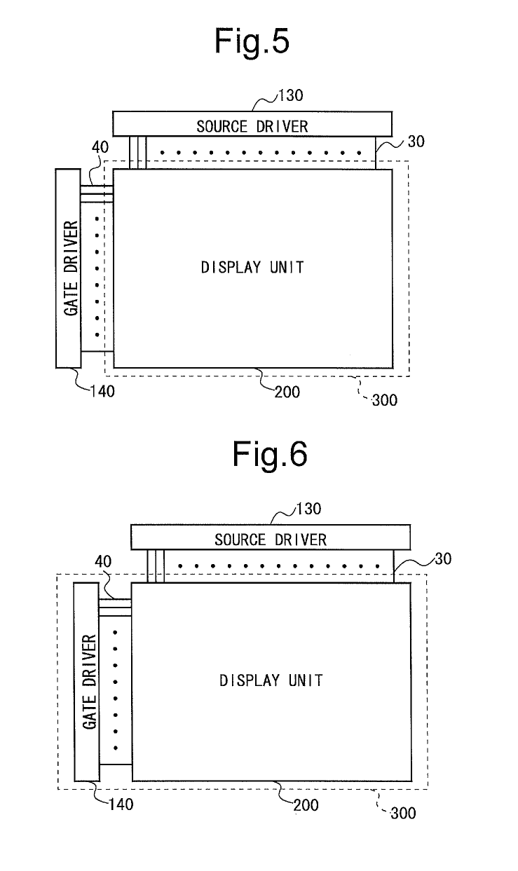

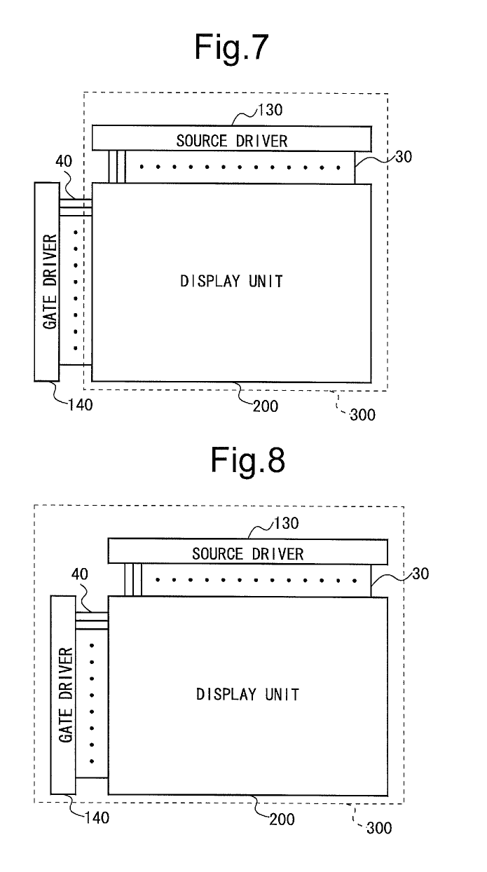

FIG. 1 is a pattern diagram showing an electrical configuration of a liquid crystal display device according to a first embodiment of the present invention. This liquid crystal display device includes a liquid crystal panel 300 as a display panel, a source driver 130 as a data signal line drive circuit, and a gate driver 140 as a scanning signal line drive circuit. The source driver 130 and the gate driver 140 are connected to a display control circuit 400. An image signal DV for displaying a color image and a timing control signal TS are inputted to the display control circuit 400 from outside of the device. The liquid crystal panel 300 includes a plurality of data signal lines 30 connected to the source driver 130, and a plurality of scanning signal lines 40 connected to the gate driver 140. The plurality of data signal lines 30 and the plurality of scanning signal lines 40 are arranged so as to cross each other. The liquid crystal panel 300 includes a plurality of pixel formation portions 10 that are arranged in a matrix form along the plurality of data signal lines 30 and the plurality of scanning signal lines 40. In the present embodiment, as shown in FIG. 5, a display unit 200 is implemented by the plurality of pixel formation portions 10, the plurality of data signal lines 30, and the plurality of scanning signal lines that are included in the liquid crystal panel 300. The source driver 130 and the gate driver 140 are implemented as an IC (Integrated Circuit) as a component separate from the liquid crystal panel 300. However, in place of a configuration shown in FIG. 5, the liquid crystal panel 300 may be what is called a driver monolithic type panel. That is, as shown in FIG. 6, the display unit 200 and the gate driver 140 may be integrally formed with a thin-film transistor and the like on the liquid crystal panel 300. Further, as shown in FIG. 7, the display unit 200 and the source driver 130 may be integrally formed with a thin-film transistor and the like on the liquid crystal panel 300. Further, as shown in FIG. 8, the display unit 200, the gate driver 140, and the source driver 130 may be integrally formed with a thin-film transistor and the like on the liquid crystal panel 300.

The liquid crystal display device according to the present invention is configured to display a color image based on the three primary colors. That is, each pixel formation portion 10 includes a sub-pixel formation portion 1r that expresses a first color component, a sub-pixel formation portion 1g that expresses a second color component, and a sub-pixel formation portion 1b that expresses a third color component. Therefore, each pixel that constitutes a color image displayed in the present embodiment includes sub-pixels of first, second, and third color components that are formed by the three sub-pixel formation portions 1r, 1g, and 1b, respectively. In the present embodiment, red (R) is employed for the first color component, green (G) is employed for the second color component, and blue (B) is employed for the third color component. Each pixel formation portion 10 is configured to arrange the sub-pixel formation portion 1r, the sub-pixel formation portion 1g, and the sub-pixel formation portion 1b that respectively express different color components which constitute the three primary colors, in the data signal line extension direction. Note that other colors may be employed for color components. A configuration for displaying a color image based on four primary colors (for example, red, green, blue, and yellow) may be employed, without limiting to the three primary colors. Hereinafter, in the case where a sub-pixel formation portion is referred to without discriminating the three kinds of sub-pixel formation portions 1r, 1g, 1b, a reference character “1x” is used for the sub-pixel formation portion.

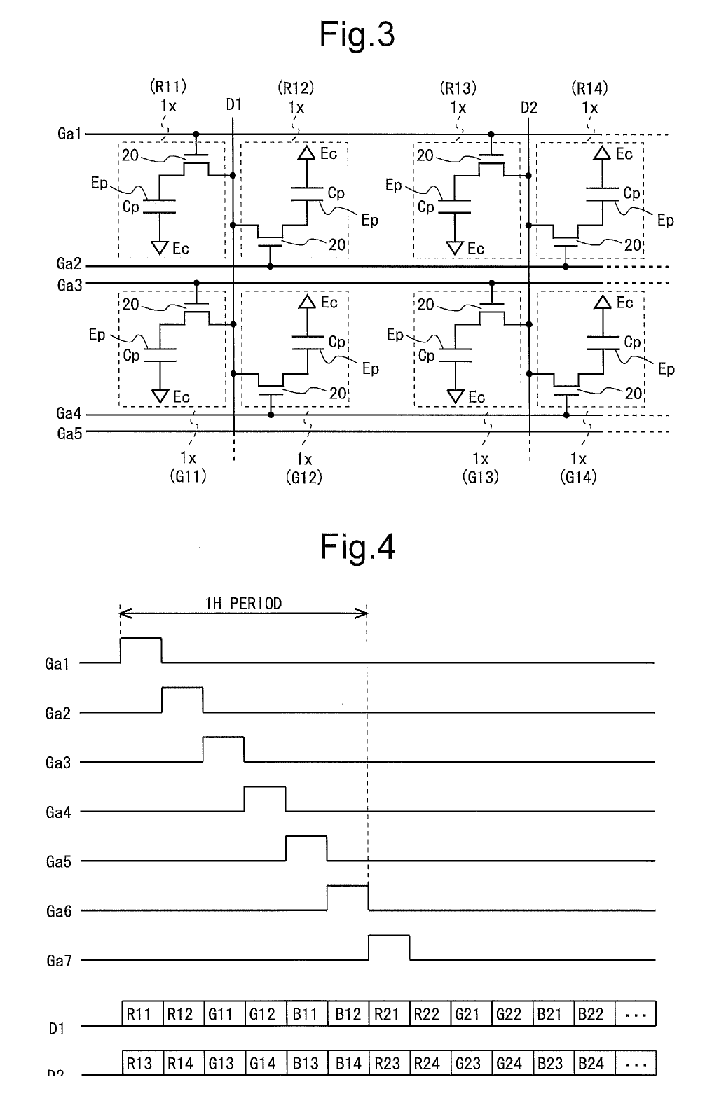

Each sub-pixel formation portion 1x includes a pixel electrode and a thin-film transistor (hereinafter, abbreviated as “TFT”) 20 as a switching element. As shown in FIG. 1, pixel electrodes included in the three sub-pixel formation portions 1r, 1g, 1b that constitute pixel formation portions of an i-th row and a j-th column (pixel formation portions included in both an i-th pixel formation portion horizontal string and a j-th pixel formation portion vertical string) of pixel formation portions arranged in a matrix form in the display unit 200 are indicated by reference characters “Rij”, “Gij”, “Bij”, respectively. The TFT 20 in each sub-pixel formation portion 1x comes into an on state or an off state according to a scanning signal applied to the scanning signal line 40 connected to this TFT 20, and a pixel electrode Xij in the sub-pixel formation portion 1x is connected to the data signal line 30 via the TFT 20 (X=R, G, B). Hereinafter, it is to be noted that the TFT 20 comes into an on state when a scanning signal Gai given to a gate terminal of this TFT 20 is at a high level (H level), and comes into an off state when the scanning signal Gai is at a low level (L level). In the liquid crystal panel 300, a common electrode is provided in common to all sub-pixel formation portions 1x of the display unit 200. The pixel electrode Xij in each sub-pixel formation portion 1x is opposite to the common electrode via a liquid crystal layer, and a pixel capacitance is formed by the pixel electrode Xij and the common electrode. This pixel capacitance is for holding a voltage corresponding to a value of a sub-pixel to be formed by the sub-pixel formation portion 1x. Thus, an equivalent circuit of the sub-pixel formation portion 1x has a configuration as shown in FIG. 3. In FIG. 3, reference characters “Cp”, “Ep”, and “Ec” denote a pixel capacitance, a pixel electrode, and a common electrode, respectively.

In the present description, sub-pixel formation portions aligned in one row in the data signal line extension direction are called a “sub-pixel formation portion vertical string”, and sub-pixel formation portions aligned in one row in the scanning signal line extension direction are called a “sub-pixel formation portion horizontal string”.

Each one data signal line 30 is arranged between a sub-pixel formation portion vertical string 3 in an odd-order from a front of the scanning signal line extension direction and a sub-pixel formation portion vertical string 3 adjacent to the sub-pixel formation portion vertical string 3 at the back of the scanning signal line extension direction. In FIG. 1, attention is focused on a data signal line 30 to which a data signal D1 is applied. The data signal line 30 is arranged between a sub-pixel formation portion vertical string 3 that includes first pixel electrodes R11, G11, B11, R21, . . . from the front of the scanning signal line extension direction and a sub-pixel formation portion vertical string 3 that is adjacent to the sub-pixel formation portion vertical string 3 at the back of the scanning signal line extension direction and that includes pixel electrodes R12, G12, B12, R22, . . . . To each data signal line 30, sub-pixel formation portion vertical strings 3 that are positioned at both sides of the data signal line 30 in the scanning signal line extension direction are connected. In FIG. 1, attention is focused on the data signal line 30 to which data signals D1 are applied. To this data signal line 30, there are connected the sub-pixel formation portion vertical string 3 that includes the pixel electrodes R11, G11, B11, R21, . . . and the sub-pixel formation portion vertical string 3 that includes the pixel electrodes R12, G12, B12, R22, . . . which are positioned at both sides of the data signal line 30 in the scanning signal line extension direction.

In this manner, in the present embodiment, each data signal line 30 corresponds to one of a plurality of sets of sub-pixel formation portion vertical strings 3, 3 that are obtained by dividing the sub-pixel formation portions of the display unit 200 such that mutually adjacent two sub-pixel formation portion vertical strings 3, 3 form one set. The each data signal line 30 is also arranged between two sub-pixel formation portion vertical strings 3, 3 that constitute a corresponding set, and is connected to each sub-pixel formation portion 1x included in the two sub-pixel formation portion vertical strings 3, 3.

Each scanning signal line 40 is arranged at both sides of each sub-pixel formation portion horizontal string in the data signal line extension direction. In FIG. 1, when attention is focused on a sub-pixel formation portion horizontal string 4 that includes pixel electrodes R11, R12, R13, R14, . . . , a scanning signal line 40 to which a scanning signal Ga1 is applied and a scanning signal line 40 to which a scanning signal Ga2 is applied are arranged respectively at both sides of the sub-pixel formation portion horizontal string 4 in the data signal line extension direction. Mutually adjacent sub-pixel formation portion vertical strings 3, 3 are connected to mutually different scanning signal lines 40. That is, as shown in FIG. 1, sub-pixel formation portions (sub-pixel formation portions which respectively include pixel electrodes R11, G11, B11, R21, G21, . . . ) 1x that constitute a first sub-pixel formation portion vertical string 3 from the front of the scanning signal line extension direction are respectively connected to odd-order scanning signal lines 40 to which scanning signals Ga1, Ga3, Ga5, Ga7, Ga9, . . . are applied, for example. Further, sub-pixel formation portions (sub-pixel formation portions which respectively include pixel electrodes R12, G12, B12, R22, 1x that constitute a second sub-pixel formation portion vertical string 3 from the front of the scanning signal line extension direction are respectively connected to even-order scanning signal lines 40 to which scanning signals Ga2, Ga4, Ga6, Ga8, Ga10, . . . are applied, for example.

In this way, according to the present embodiment, each sub-pixel formation portion horizontal string 4 corresponds to one of a plurality of sets of scanning signal lines 40 that are obtained by dividing the scanning signal lines of the display unit 200 such that adjacent two scanning signal lines (an odd-order scanning signal line and an even-order scanning signal line) 40, 40 form one set. The each sub-pixel formation portion horizontal string 4 is also arranged between two scanning signal lines 40, 40 that constitute a corresponding set. Each sub-pixel formation portion 1x that constitutes an odd-order sub-pixel formation portion vertical string 3 is connected to an odd-order scanning signal line 40, and each sub-pixel formation portion 1x that constitutes an even-order sub-pixel formation portion vertical string 3 is connected to an even-order scanning signal line 40. Therefore, one of two scanning signal lines 40, 40 that constitute each set of the plurality of sets of scanning signal lines is connected to one of two sub-pixel formation portions 1x connected to the same data signal line out of sub-pixel formation portions 1x included in a sub-pixel formation portion horizontal string 4 corresponding to the set, and the other of the two scanning signal lines 40, 40 is connected to the other of the two sub-pixel formation portions 1x.

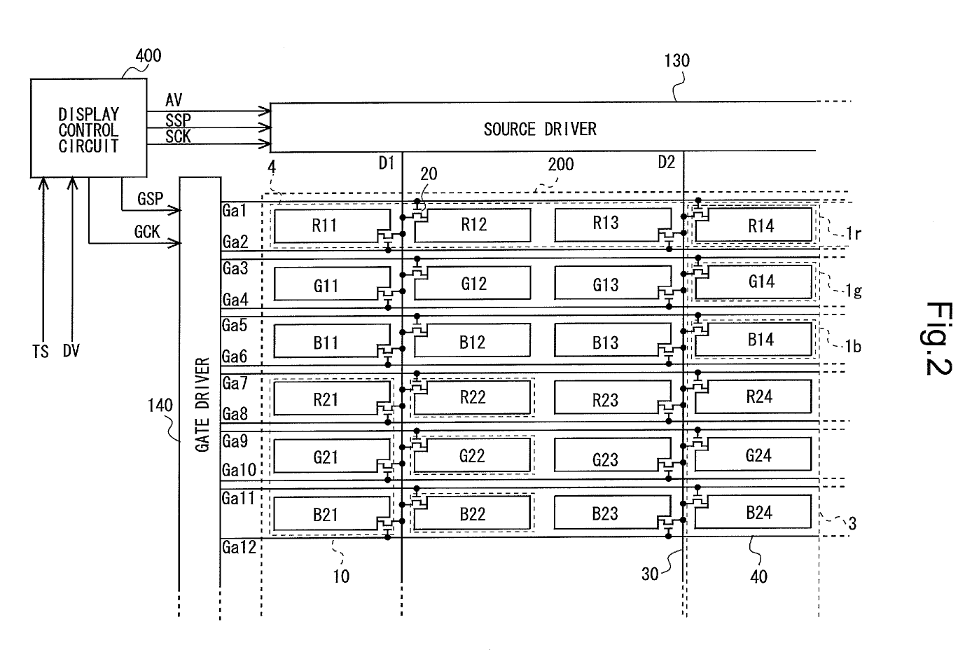

Note that in the present embodiment, although sub-pixel formation portions are arranged in the order of R, G, B from the front of the data signal line extension direction, other order such as B, G, R may be used. The TFT 20 may be arranged as shown in FIG. 2, instead of the arrangement shown in FIG. 1. That is, the TFT 20 may be arranged such that each sub-pixel formation portion 1x which constitutes an odd-order sub-pixel formation portion vertical string 3 is connected to an even-order scanning signal line 40 and that each sub-pixel formation portion 1x which constitutes an even-order sub-pixel formation portion vertical string 3 is connected to an odd-order scanning signal line 40.

### 1.2 Operation

Next, an operation of the liquid crystal display device according to the present embodiment will be described.

Hereinafter, for the sake of description, a sub-pixel formation portion including the pixel electrode Xij is expressed by “Xij” (X=R, G, B; i=1, 2, . . . ; j=1, 2, . . . ) in place of the reference character “1x”, when necessary (this is similarly applied to an description of a modification of the present embodiment and other embodiments).

FIG. 4 is a timing chart showing an operation of the liquid crystal display device in the present embodiment shown in FIG. 1. Each data signal line 30 of the display unit 200 is applied with a data signal Dk corresponding to an arrangement of a sub-pixel formation portion Xij, from the source driver 130. A scanning signal that indicates a timing at which a corresponding sub-pixel formation portion Xij takes out the data signal Dk is applied from the gate driver 140 to the scanning signal line 40. For example, when a first scanning signal line 40 is set in an active state by setting the scanning signal Ga1 to an H level, both a TFT 20 of the sub-pixel formation portion R11 and a TFT 20 of a sub-pixel formation portion R13 come into an on state. In this case, the data signal D1 is taken into the sub-pixel formation portion R11, and the data signal D2 is taken into the sub-pixel formation portion R13. Next, when a second scanning signal line 40 is set in an active state by setting the scanning signal Ga2 to an H level, both a TFT 20 of a sub-pixel formation portion R12 and a TFT 20 of a sub-pixel formation portion R14 come into an on state. In this case, the data signal D1 is taken into the sub-pixel formation portion R12, and the data signal D2 is taken into the sub-pixel formation portion R14. In this way, a data signal corresponding to a sub-pixel formation portion Xij is taken into the sub-pixel formation portion Xij by matching an H level of the scanning signal Gai, that is, an activation state of a scanning signal line 40.

The source driver 130 applies a data signal Dk to each data signal line 30 such that a color image is displayed in the display unit 200 by taking in the data signal Dk by the sub-pixel formation portion Xij as described above. That is, the source driver 130 alternately applies a data signal that indicates a sub-pixel which a sub-pixel formation portion Xij included in one of two sub-pixel formation portion vertical strings 3, 3 corresponding to each data signal line 30 should form and a data signal that indicates a sub-pixel which a sub-pixel formation portion Xij included in the other of the two sub-pixel formation portion vertical strings 3, 3 should form, to each of the data signal line 30, in conjunction with activation of scanning signal lines of the display unit 200. For example, to the first data signal line 30, the source driver 130 sequentially applies a data signal that indicates a sub-pixel which a first sub-pixel formation portion R11 in the first sub-pixel formation portion vertical string 3 should form, a data signal that indicates a sub-pixel which a first sub-pixel formation portion R12 in the second sub-pixel formation portion vertical string 3 should form, a data signal that indicates a sub-pixel which a second sub-pixel formation portion G11 in the first sub-pixel formation portion vertical string 3 should form, a data signal that indicates a sub-pixel which a second sub-pixel formation portion G12 in the second sub-pixel formation portion vertical string 3 should form, . . . , as the data signal D1, in conjunction with sequential activation of scanning signal lines 40 of the display unit 200, as shown in FIG. 4.

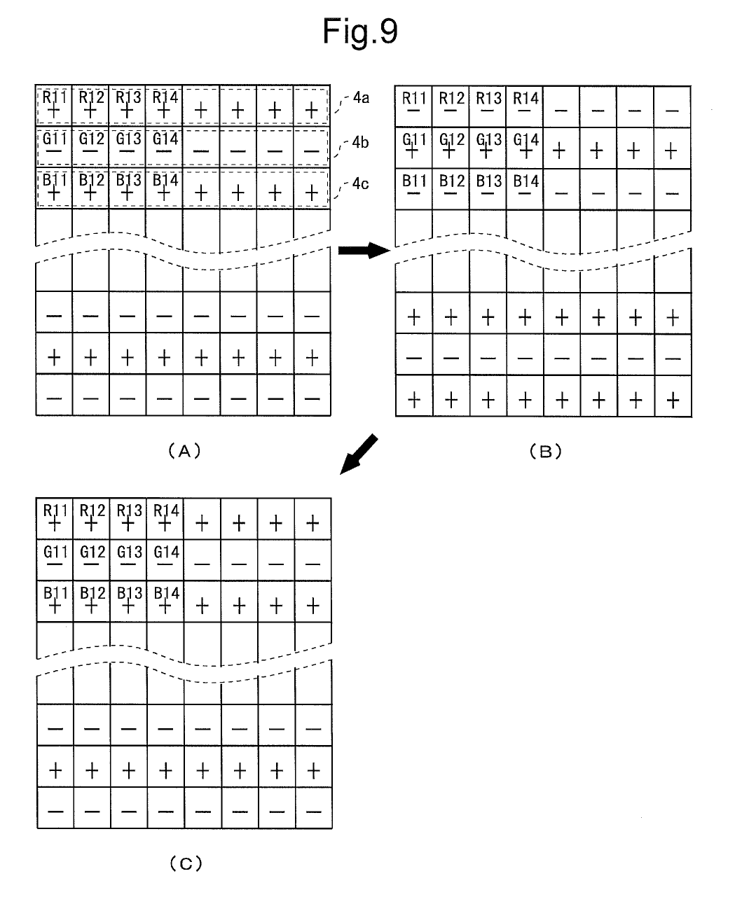

FIG. 9(A) to FIG. 9(C) are transition diagrams showing a method of inversion-driving a liquid crystal display in the present embodiment. FIG. 9(A), FIG. 9(B), and FIG. 9(C) show polarities of data signals Dk that are taken into sub-pixel formation portions Xij in an n-th frame, an (n+1)-th frame, and an (n+2)-th frame, respectively. Each element in a matrix corresponds to a sub-pixel formation portion Xij. The source driver 130 in the present embodiment inverts a polarity of a data signal Dk taken into each sub-pixel formation portion Xij in each one frame period. In one frame period, polarities of data signals taken into sub-pixel formation portions mutually adjacent in the scanning signal line extension direction are set mutually the same. In one frame period, polarities of data signals taken into sub-pixel formation portions are inverted in each one sub-pixel formation portion horizontal string 4. For example, when attention is focused on the sub-pixel formation portion G12, in the frame shown in FIG. 9(A), a polarity is “−”. In the next frame shown in FIG. 9(B), a polarity is “+”, and in the further next frame shown in FIG. 9(C), a polarity is “−”. Further, when attention is focused on the sub-pixel formation portion G12 in the frame shown in FIG. 9(A), a polarity of a data signal Dk taken into this sub-pixel formation portion G12, and polarities of data signals Dk taken into the sub-pixel formation portions G11 and G13 adjacent to the sub-pixel formation portion G12 in the scanning signal line extension direction are “−”. Further, when attention is focused on a sub-pixel formation portion horizontal string 4a in the frame shown in FIG. 9(A), polarities of data signals taken into the sub-pixel formation portion horizontal string 4a are “+”. Polarities of data signals taken into a sub-pixel formation portion horizontal string 4b adjacent to the sub-pixel formation portion horizontal string 4a are inverted and are “−”, and polarities of data signals taken into a sub-pixel formation portion horizontal string 4c adjacent to the sub-pixel formation portion horizontal string 4b are further inverted and are “+”. In the present embodiment, in one frame period, polarities of data signals taken into a sub-pixel formation portion horizontal string are inverted in each one line. However, the polarities may be inverted in each two or three lines.

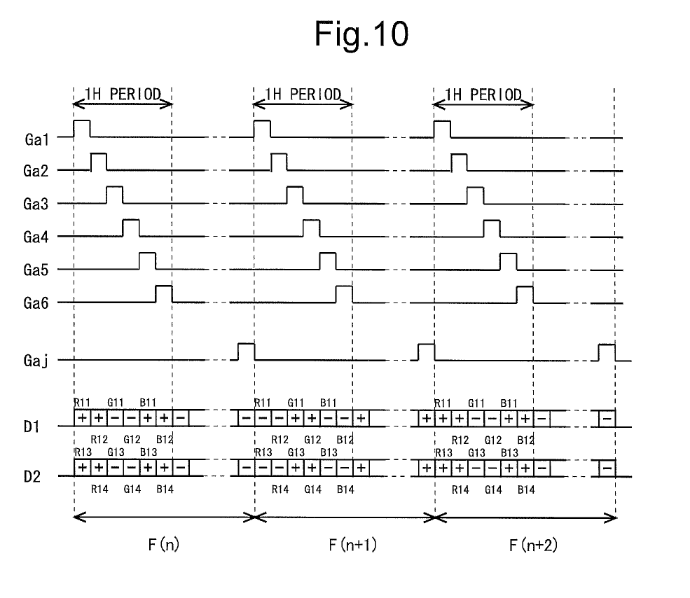

FIG. 10 is a timing chart for describing the method of inversion-driving concerning FIG. 9. First, during an n-th frame period F(n), polarities of the data signals D1 and D2 are in the order of “+, +, −, −, +, −, . . . ”. During an (n+1)-th frame period F(n+1), polarities of the data signals D1 and D2 become the order of “−, −, +, +, −, −, . . . ” that are inversions of the polarities in F(n). Further, during an (n+2)-th frame period F(n+2), polarities of the data signals D1 and D2 become the order of “+, +, −, −, +, +, . . . ” that are inversions of the polarities in F(n+1).

In the present embodiment, in one horizontal scanning period (1 H period), a data signal Dk is taken from each data signal line 30 into two pixel formation portions 10 (six sub-pixel formation portions) (see FIG. 1, FIG. 10). The gate driver 140 sequentially sets the scanning signal lines 40 in the display unit 200 to an activation state, by setting scanning signals to an H level in each period of ⅙ of one H period in the order of Ga1, Ga2, Ga3, Ga4, . . . . However, when a scanning signal and a data signal correspond to each other, another order may be employed. For example, the gate driver 140 may sequentially set scanning signals to an H level in the order of Ga2, Ga1, Ga4, Ga3, . . . (accordingly, the scanning signal lines 40 in the display unit 200 come into an activation state in this order), and the source driver 130 may sequentially apply the data signal D1 in the order of R12, R11, G12, G11.

### 1.3 Advantages

According to the present embodiment, the number of data signal lines 30 becomes a half of the number of pixel formation portions (m) in the scanning signal line extension direction, that is, m/2. Because the conventional display device requires 3×m data signal lines, the number can be set to ⅙ according to the present embodiment. Therefore, the amount of circuits in the source driver 130 decreases, and accordingly, cost and current consumption of the source driver 130 can be decreased. Note that the number of scanning signal lines 40 becomes six times of the number of scanning signal lines of a gate driver in the conventional display device. Therefore, cost of the gate driver 140 in the present embodiment increases. However, in general, cost of a gate driver that outputs digital signals is lower than cost of a source driver that outputs analog signals. Consequently, according to the present embodiment, cost and current consumption of the display device as a whole can be decreased.

Note that in the present embodiment, degradation of a display quality due to inversion drive can be also suppressed, like in the conventional practice, byline inverting polarities of data signals in each sub-pixel formation portion horizontal string.

### 1.4 Modifications

### 1.4.1 First Modification

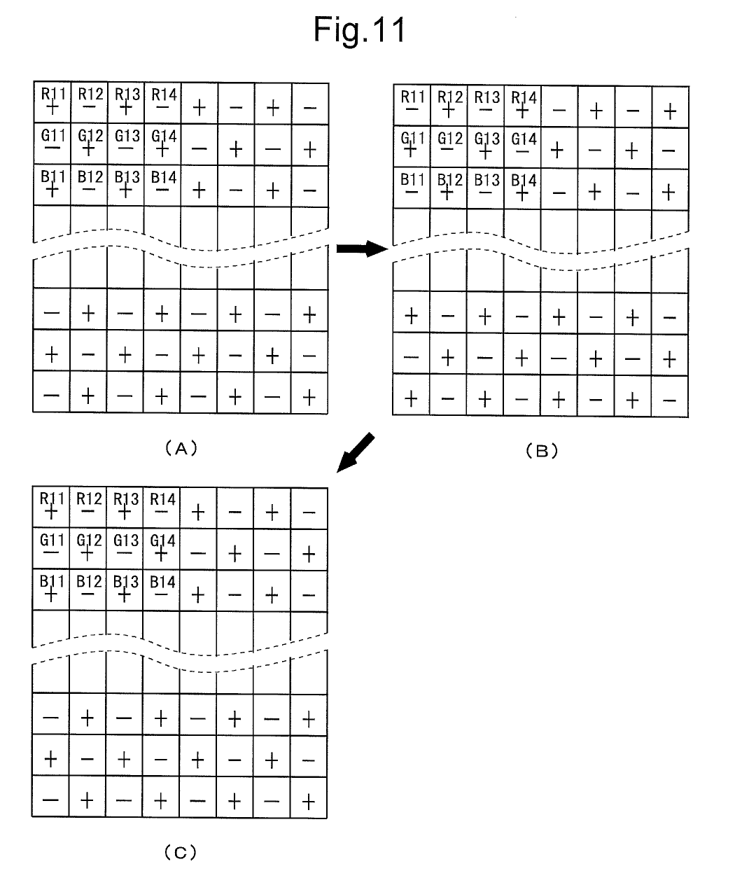

Next, a first modification of the above embodiment will be described. FIG. 11(A) to FIG. 11(C) are transition diagrams showing a method of inversion-driving a liquid crystal display device in the present modification. FIG. 11(A), FIG. 11(B), and FIG. 11(C) show polarities of data signals taken into sub-pixel formation portions Xij in an n-th frame, an (n+1)-th frame, and an (n+2)-th frame, respectively. Each element in a matrix corresponds to a sub-pixel formation portion Xij. The source driver 130 in the present embodiment inverts a polarity of a data signal Dk taken into each sub-pixel formation portion Xij in each one frame period. In one frame period, polarities of data signals taken into sub-pixel formation portions mutually adjacent in the scanning signal line extension direction are set different from each other. Further, in one frame period, polarities of data signals taken into sub-pixel formation portions mutually adjacent in the data signal line extension direction are set different from each other. For example, when attention is focused on the sub-pixel formation portion G12, in the frame shown in FIG. 11(A), a polarity is “+”. In the next frame shown in FIG. 11(B), a polarity is “−”, and in the further next frame shown in FIG. 11(C), a polarity is “+”. Further, when attention is focused on the sub-pixel formation portion G12 in the frame shown in FIG. 11(A), a polarity of a data signal taken into the sub-pixel formation portion G12 is “+”, and polarities of data signals Dk taken into the sub-pixel formation portions G11 and G13 adjacent to the sub-pixel formation portion G12 in the scanning signal line extension direction are “−”. Further, when attention is focused on the sub-pixel formation portion G12 in the frame shown in FIG. 11(A), a polarity of a data signal Dk taken into the sub-pixel formation portion G12 is “+”, and polarities of data signals Dk taken into the sub-pixel formation portions R12 and B12 adjacent to the sub-pixel formation portion G12 in the data signal line extension direction are “−”.

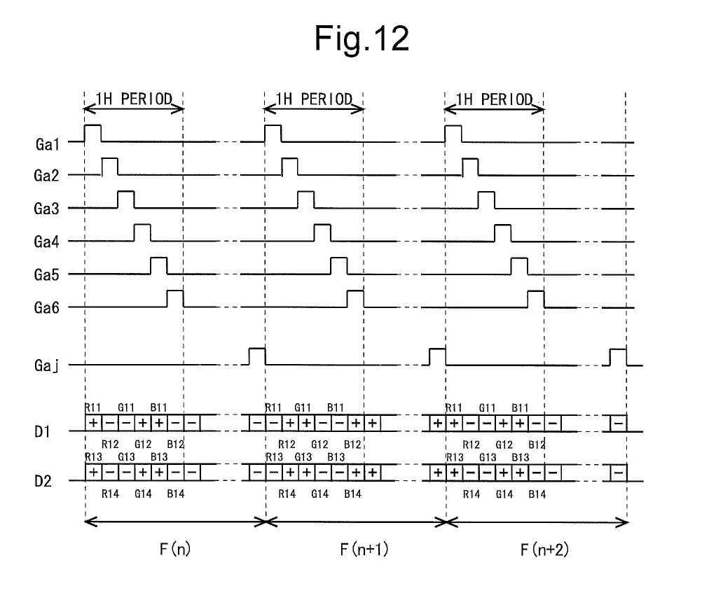

FIG. 12 is a timing chart for describing the method of inversion-driving concerning FIG. 11. First, during an n-th frame period F(n), polarities of the data signals D1 and D2 are in the order of “+, −, −, +, +, −, . . . ”. During an (n+1)-th frame period F(n+1), polarities of the data signals D1 and D2 become the order of “−, +, +, −, −, +, . . . ” that are inversions of the polarities in F(n). Further, during an (n+2)-th frame period F(n+2), polarities of the data signals D1 and D2 become the order of “+, −, −, +, +, −, . . . ” that are inversions of the polarities in F(n+1).

According to the present modification, polarities of data signals are dot inverted, and therefore, degradation of a display quality by inversion drive can be more suppressed than in the first embodiment.

### 1.4.2 Second Modification

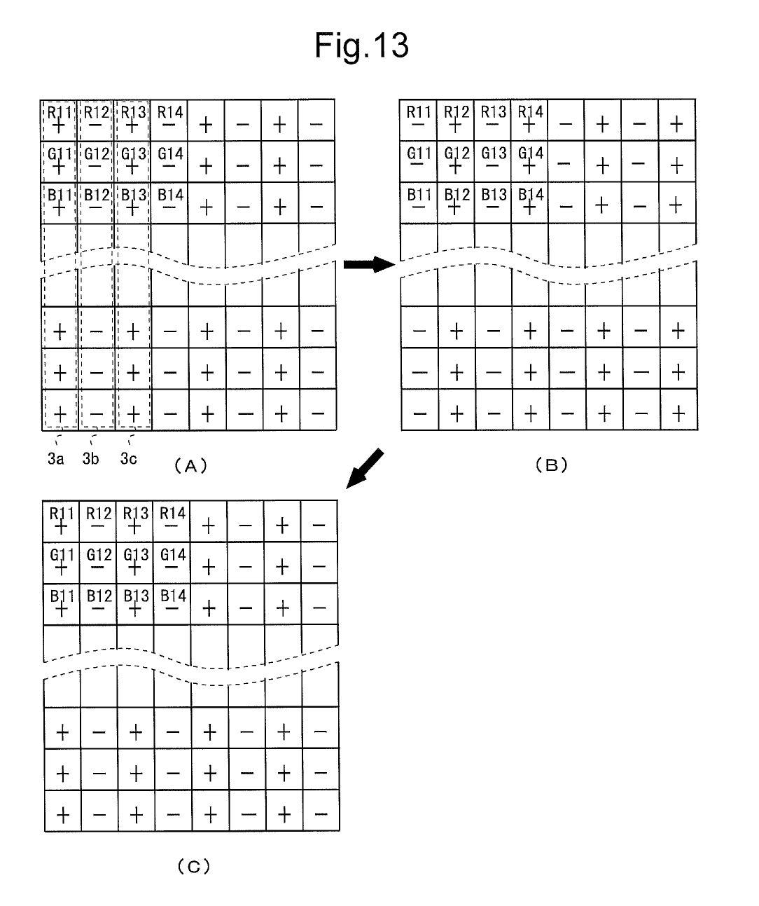

Next, a second modification of the above embodiment will be described. FIG. 13(A) to FIG. 13(C) are transition diagrams showing a method of inversion-driving a liquid crystal display device in the present modification. FIG. 13(A), FIG. 13(B), and FIG. 13(C) show polarities of data signals Dk taken into sub-pixel formation portions Xij in an n-th frame, an (n+1)-th frame, and an (n+2)-th frame, respectively. Each element in a matrix corresponds to a sub-pixel formation portion Xij. The source driver 130 in the present embodiment inverts a polarity of a data signal Dk taken into each sub-pixel formation portion Xij in each one frame period. In one frame period, polarities of data signals taken into sub-pixel formation portions mutually adjacent in the data signal line extension direction are set mutually the same. Further, in one frame period, polarities of data signals taken into sub-pixel formation portions are inverted in each one sub-pixel formation portion vertical string 3. For example, when attention is focused on the sub-pixel formation portion G12, in the frame shown in FIG. 13(A), a polarity is “−”. In the next frame shown in FIG. 13(B), a polarity is “+”, and in the further next frame shown in FIG. 13(C), a polarity is “−”. Further, when attention is focused on the sub-pixel formation portion G12 in the frame shown in FIG. 13(A), a polarity of a data signal taken into the sub-pixel formation portion G12 and polarities of data signals taken into the sub-pixel formation portions R12 and B12 adjacent to the sub-pixel formation portion G12 in the data signal line extension direction are “−”. Further, when attention is focused on a sub-pixel formation portion vertical string 3a in the frame shown in FIG. 13(A), polarities of data signals taken into the sub-pixel formation portion vertical string 3a are “+”, and polarities of data signals taken into a sub-pixel formation portion vertical string 3b adjacent to the sub-pixel formation portion vertical string 3a are inverted and are “−”. Polarities of data signals taken into a sub-pixel formation portion vertical string 3c adjacent to the sub-pixel formation portion vertical string 3b are further inverted and are “+”. In the present modification, in one frame period, polarities of data signals taken in a sub-pixel formation portion vertical string are inverted in each one line. However, the polarities may be inverted in each two or three lines.

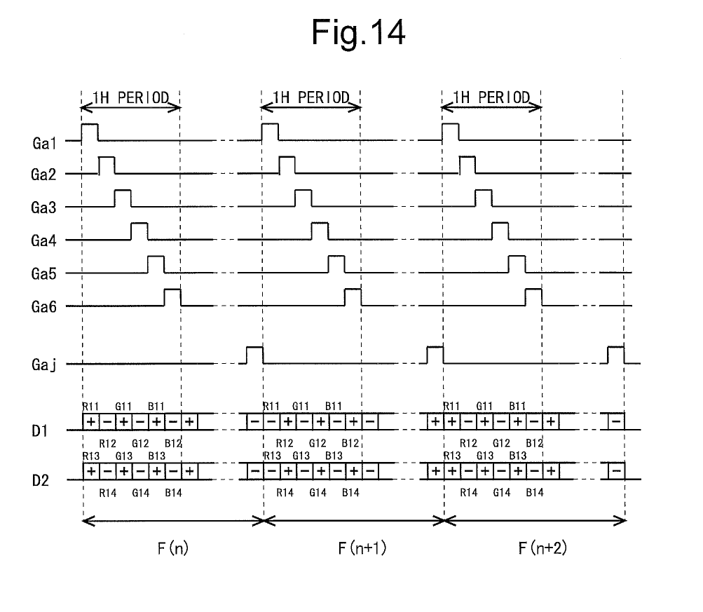

FIG. 14 is a timing chart for describing the method of inversion-driving concerning FIG. 13. First, during an n-th frame period F (n), polarities of the data signals D1 and D2 are in the order of “+, −, +, −, +, −, . . . ”. During an (n+1)-th frame period F(n+1), polarities of the data signals D1 and D2 become the order of “−, +, −, +, −, +, . . . ” that are inversions of the polarities in F(n). Further, during an (n+2)-th frame period F(n+2), polarities of the data signals D1 and D2 become the order of “+, −, +, −, +, −, . . . ” that are inversions of the polarities in F(n+1).

According to the present modification, polarities of data signals are inverted in each sub-pixel formation portion vertical string, and therefore, degradation of a display quality by inversion drive can be suppressed.

### 2. Second Embodiment

Next, a liquid crystal display device according to a second embodiment of the present invention will be described. The liquid crystal display device according to the present embodiment has a configuration basically similar to that in the first embodiment, except that an inversion driving system and the scanning signals Ga1, Ga2, . . . are different from those in the first embodiment. In the following, these differences will be mainly described, and detailed descriptions of other points will be omitted by affixing the same reference characters to the same or corresponding portions.

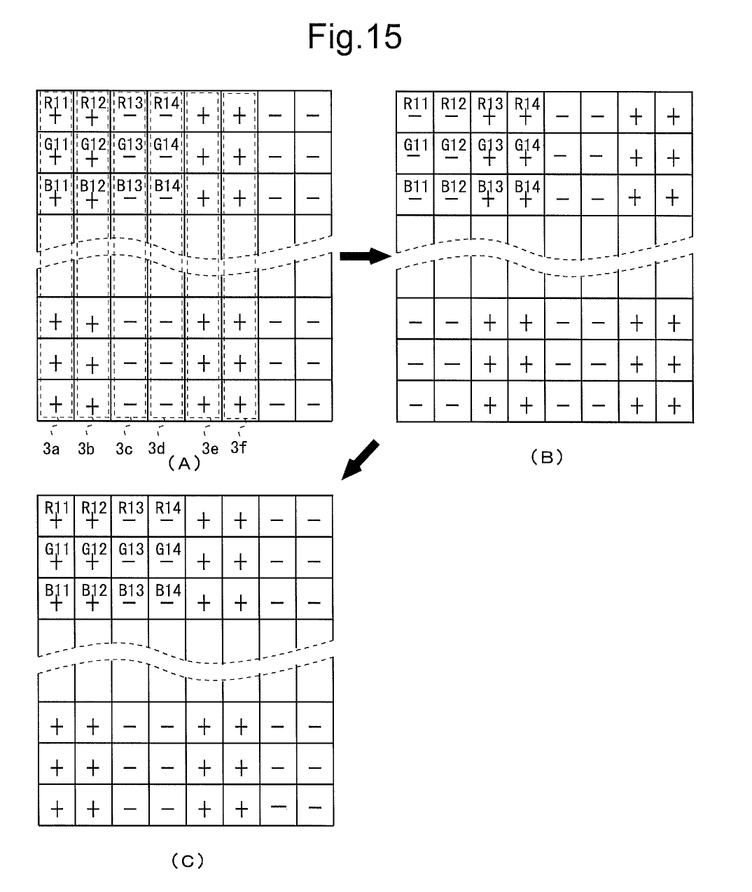

FIG. 15(A) to FIG. 15(C) are transition diagrams showing an inversion driving method in the present embodiment. FIG. 15(A), FIG. 15(B), and FIG. 15(C) show polarities of data signals Dk taken into sub-pixel formation portions Xij in an n-th frame, an (n+1)-th frame, and an (n+2)-th frame, respectively. Each element in a matrix corresponds to a sub-pixel formation portion Xij. A source driver 130 in the present embodiment inverts a polarity of a data signal Dk taken into each sub-pixel formation portion Xij in each one frame period, and also sets polarities of data signals taken into sub-pixel formation portions mutually adjacent in the data signal line extension direction as mutually the same in one frame period, in a similar manner to that in the second modification (see FIG. 13) of the first embodiment. However, in the present embodiment, unlike in the second modification shown in FIG. 13, during one frame period, polarities of data signals taken into sub-pixel formation portions are inverted in each two sub-pixel formation portion vertical strings that include sub-pixel formation portions 1x connected to the same data signal line 30. For example, in a frame shown in FIG. 15(A), when attention is focused on two sub-pixel formation portion vertical strings 3a, 3b including sub-pixel formation portions connected to the same data signal line 30, polarities of data signals taken into the two sub-pixel formation portion vertical strings 3a, 3b are “+”. Polarities of data signals taken into two sub-pixel formation portion vertical strings 3c, 3d adjacent to the two sub-pixel formation portion vertical strings 3a, 3b, that is, the two sub-pixel formation portion vertical strings 3c, 3d that include sub-pixel formation portions connected to a data signal line 30 adjacent to the above data signal line 30, are “−”. Further, polarities of data signals taken into two sub-pixel formation portion vertical strings 3e, 3f adjacent to the two sub-pixel formation portion vertical strings 3c, 3d are “+”.

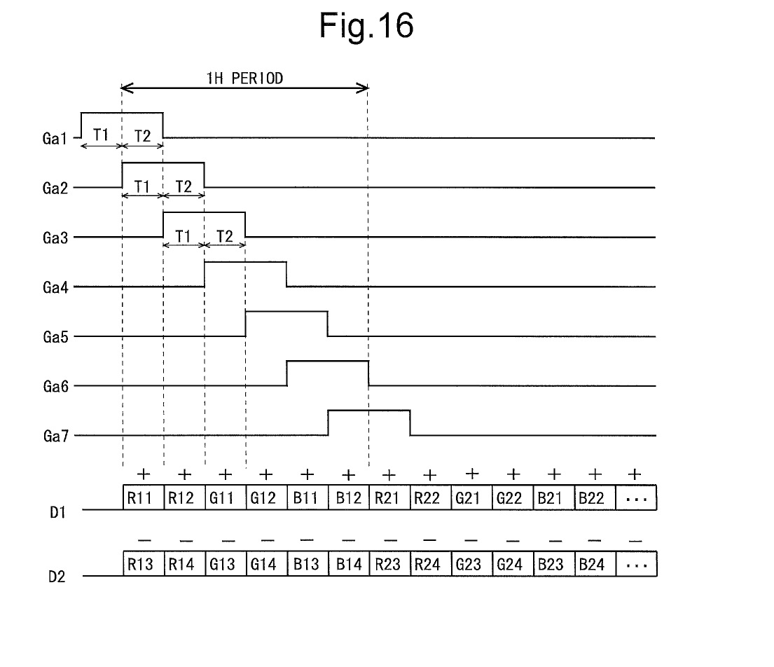

According to the above inversion driving system, polarities of data signals applied to mutually adjacent data signal lines 30, 30 are different from each other, but polarities of data signals Dk applied to each data signal line 30 in one frame period do not change. In the present embodiment, based on this assumption, a pixel capacitance Cp included in each sub-pixel formation portion 1x is preliminarily charged, by doubling a pulse width (a period of an H level) of each scanning signal Gai (I=1, 2, . . . ). FIG. 16 is a timing chart for describing this preliminary charge operation (a precharge operation).

In the first embodiment, as shown in FIG. 4, each scanning signal Gai (i=1, 2, . . . ) becomes at an H level during only a ⅙ period of 1H period in each one frame period (hereinafter, a period when an i-th scanning signal line 40 becomes in an activation state when the scanning signal Gai becomes at an H level is called an “activation period”). On the other hand, in the present embodiment, as shown in FIG. 16, scanning signals Ga1, Ga2, . . . are generated by the gate driver 140 such that each scanning signal Gai becomes at an H level during a 2/6 period of 1H period in each one frame period and that a first half period T1 of a period when each scanning signal Gai+1 becomes at an H level is superimposed in time with a latter half period T2 of a scanning signal Gai one before (a scanning signal Gai applied to a scanning signal line 40 one before in the arrangement order).

For example, a first half period T1 of an activation period (an H level period of a scanning signal Ga2) of a second scanning signal line 40 is superimposed in time with a latter half period T2 of an activation period (an H level period of a scanning signal Ga1) of a first scanning signal line 40. When attention is focused on this period of superimposition in time, in the focused period, data signals are taken into sub-pixel formation portions connected to the first scanning signal line 40 and the second scanning signal line 40. In the case of the configuration shown in FIG. 1, data signals D1 are taken into the sub-pixel formation portions R11, R12, and data signals D2 are taken into the sub-pixel formation portions R13, R14. As can be seen from FIG. 16, at this time, the data signal D1 indicates a sub-pixel to be formed in the sub-pixel formation portion R11, and the data signal D2 indicates a sub-pixel to be formed in the sub-pixel formation portion R13. Therefore, in the focused period, the sub-pixel formation portions R11, R13 connected to the first scanning signal line 40 take in the data signals D1, D2 that respectively indicate sub-pixels to be formed, but the sub-pixel formation portions R12, R14 connected to the second scanning signal line 40 do not take in the data signals D1, D2 that respectively indicate sub-pixels to be formed.

However, polarities of the data signals D1, D2 that the sub-pixel formation portions R12, R14 should respectively take in during the focused period are the same as polarities of data signals that indicate sub-pixels that the sub-pixel formation portions R12, R14 should respectively form. Therefore, by taking in the data signals D1, D2 during the focused period into the sub-pixel formation portions R12, R14 connected to the second scanning signal line 40, pixel capacitances Cp of the sub-pixel formation portions R12, R14 are preliminarily charged.

Here, the focused period corresponds to the first half period T1 of the activation period (an H level period of the scanning signal Ga2) of the second scanning signal line 40. Therefore, in the sub-pixel formation portion 1x(e.g., R12, R14) connected to the second scanning signal line 40, pixel capacitances Cp are preliminarily charged in the first half period T1 of the activation period of the second scanning signal line 40. This is similarly applied to sub-pixel formation portions 1x connected to other scanning signal lines 40. Note that, immediately before preliminary charging, pixel capacitances Cp of sub-pixel formation portions 1x are charged in advance by voltages having polarities opposite to polarities of data signals Dk taken in for the preliminary charging (see FIG. 15).

As can be seen from FIG. 16, in the latter half period T2 of the activation period of each scanning signal line 40, data signal D1, D2, . . . that indicate sub-pixels to be formed by sub-pixel formation portions 1x (Xij) connected to the scanning signal line 40 are taken into the sub-pixel formation portions 1x, and pixel capacitances Cp are charged. Therefore, a pixel capacitance Cp of each sub-pixel formation portion 1x connected to each scanning signal line 40 is preliminarily charged in the first half period T1 of the activation period of the scanning signal line 40. In the latter half period T2 of the activation period, the pixel capacitance Cp of each sub-pixel formation portion 1x is charged by a data signal Dk that indicates a sub-pixel to be formed by the sub-pixel formation portion 1x. Hereinafter, the first half period T1 of the activation period (an H level period of each scanning signal Gai) of each scanning signal line 40 is called a “preliminary charge period”, and the latter half period T2 is called a “main charge period”.

In the present embodiment, immediately before each sub-pixel formation portion 1x (Xij) takes in a data signal Dk which indicates a sub-pixel to be formed by the sub-pixel formation portion 1x, that is, in a preliminary charge period T1 as a first half period of an activation period of a scanning signal line 40 connected to the sub-pixel formation portion 1x, the sub-pixel formation portion 1x takes in a data signal Dk which indicates another sub-pixel (an adjacent sub-pixel in the present embodiment) of the same polarity as that of a data signal Dk which indicates the sub-pixel, and a pixel capacitance Cp of the sub-pixel formation portion 1x is preliminarily charged by the data signal Dk that indicates corresponding another sub-pixel. Accordingly, a charge shortage due to an increase in the number of sub-pixel formation portions 1x connected to one data signal line 30 can be prevented. Therefore, according to the present embodiment, cost and current consumption of the display device as a whole can be decreased, by decreasing cost and current consumption of the source driver 130, in a similar manner to that in the first embodiment, while suppressing reduction of a display quality due to a charge shortage of the pixel capacitance Cp.

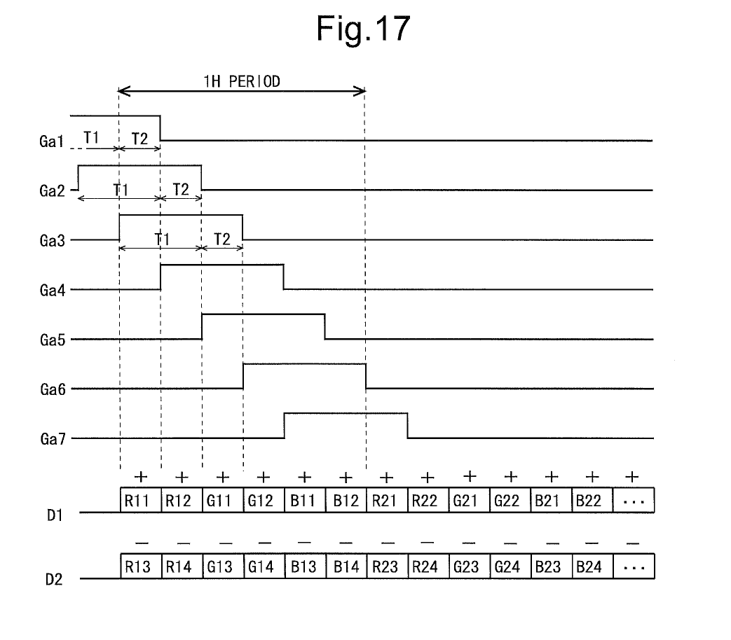

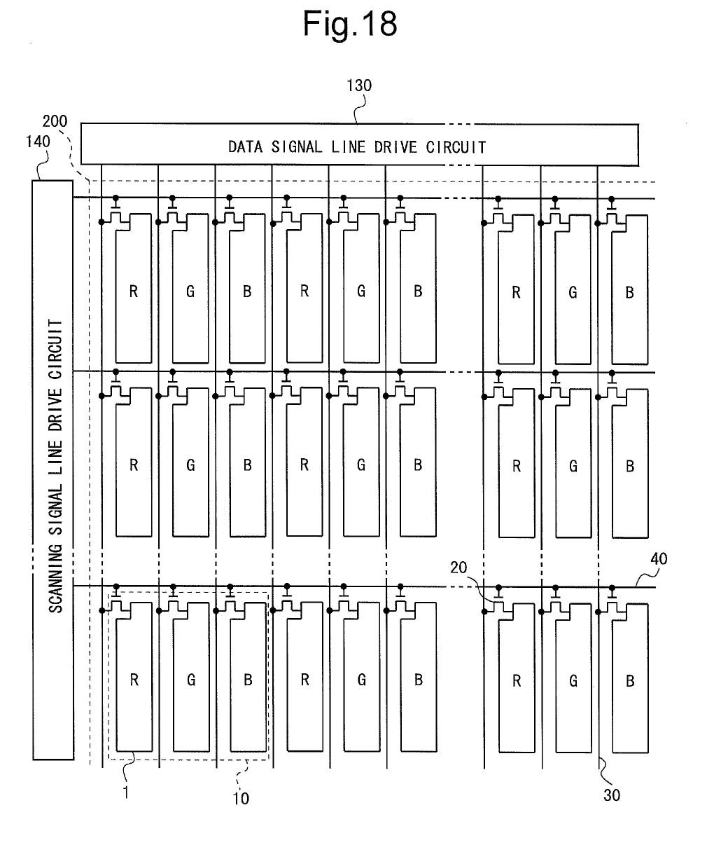

In the present embodiment, based on the assumption of the inversion driving method shown in FIG. 15, a preliminary charge period T1 of a length of ⅙ of the 1H period is provided immediately before a main charge period T2 as shown in FIG. 16. However, in place of this, a preliminary charge period T1 of a length of 2/6 of the 1H period may be configured to be provided immediately before a main charge period T2, as shown in FIG. 17 (in this case, the inversion driving method shown in FIG. 15 is the assumption). More generally, the preliminary charge period T1 may be a predetermined period prior to and close to the main charge period T2 in the same frame period, and may be a period when a polarity of each data signal Dk becomes the same as a polarity in the main charge period T2, and the inversion driving method shown in FIG. 15 is not an essential assumption.

In the case of a display device that does not perform an inversion drive unlike the liquid crystal display device, a condition concerning identity of a polarity of a data signal is not necessary.

### 3. Others

The TFT 20 as a switching element included in a sub-pixel formation portion in the first embodiment and the second embodiment can be manufactured with amorphous silicon (a-Si), for example. However, in place of this, the TFT 20 may be manufactured by using any one of polysilicon (p-Si), microcrystalline silicon (μC-Si), and indium gallium zinc oxide (IGZO).

In the first embodiment and the second embodiment, descriptions are made by taking an active matrix-type liquid crystal display device that displays a color image as an example. However, the present invention is not limited to this, and the present invention can be also applied to different kinds of display devices such as an organic EL (Electroluminescenece) display device so far as the device is an active matrix-type display device that displays a color image.

### INDUSTRIAL APPLICABILITY

The present invention can be applied to an active matrix-type display panel and a display device including the same.

### DESCRIPTION OF REFERENCE CHARACTERS

1x, Xij: SUB-PIXEL FORMATION PORTION (x=r, g, b; X=R, G, B)
3: SUB-PIXEL FORMATION PORTION VERTICAL STRING
4: SUB-PIXEL FORMATION PORTION HORIZONTAL STRING
10: PIXEL FORMATION PORTION
20: THIN-FILM TRANSISTOR (TFT) (SWITCHING ELEMENT)
30: DATA SIGNAL LINE
40: SCANNING SIGNAL LINE
130: SOURCE DRIVER (DATA SIGNAL LINE DRIVE CIRCUIT)
140: GATE DRIVER (SCANNING SIGNAL LINE DRIVE CIRCUIT)
200: DISPLAY UNIT
300: LIQUID CRYSTAL PANEL (DISPLAY PANEL)
400: DISPLAY CONTROL CIRCUIT
Cp: PIXEL CAPACITANCE
Ep, Xij: PIXEL ELECTRODE (X=R, G, B)

1. A display panel for displaying a color image based on a predetermined number of primary colors, the display panel comprising:
a plurality of data signal lines extending in a first direction;
a plurality of scanning signal lines extending in a second direction and crossing the plurality of data signal lines; and
a plurality of pixel formation portions arranged in a matrix form along the plurality of data signal lines and the plurality of scanning signal lines, wherein
each pixel formation portion is configured to arrange in the first direction a predetermined number of sub-pixel formation portions for forming sub-pixels that respectively express the predetermined number of primary colors,
each data signal line corresponds to one of a plurality of sets of sub-pixel formation portion strings obtained by dividing sub-pixel formation portions in the plurality of pixel formation portions into sets by using mutually adjacent two sub-pixel formation portion strings extending in the first direction as one set, is arranged between two sub-pixel formation portion strings constituting a corresponding set, and is connected to each sub-pixel formation portion included in the two sub-pixel formation portion strings,
each sub-pixel formation portion string extending in the second direction corresponds to one of a plurality of sets of scanning signal lines obtained by dividing the plurality of scanning signal lines into sets by using adjacent two scanning signal lines as one set, and is arranged between two scanning signal lines constituting a corresponding set, and
one of two scanning signal lines constituting each set of the plurality of sets of scanning signal lines is connected to one of two sub-pixel formation portions connected to the same data signal line of a sub-pixel formation portion included in a sub-pixel formation portion string corresponding to the set, and the other of the two scanning signal lines is connected to the other of the two sub-pixel formation portions.

2. The display panel according to claim 1, wherein
the color image is based on three primary colors, and
each pixel formation portion is configured to arrange in the first direction three sub-pixel formation portions for forming three sub-pixels that respectively correspond to the three primary colors.

3. A display device to display a color image based on the predetermined number of primary colors, the display device comprising:
a display panel according to claim 1;
a data signal line drive circuit for applying a plurality of data signals to express the color image respectively to the plurality of data signal lines; and
a scanning signal line drive circuit for selectively activating the plurality of scanning signal lines, wherein
each sub-pixel formation portion takes in a data signal applied to a data signal line connected to the sub-pixel formation portion, when a scanning signal line connected to the sub-pixel formation portion is activated.

4. The display device according to claim 3, wherein
at least one of the data signal line drive circuit and the scanning signal line drive circuit is formed integrally with the plurality of pixel formation portions on the display panel.

5. The display device according to claim 3, wherein
each sub-pixel formation portion includes:
a switching element to come into an on state or an off state depending on whether a scanning signal line connected to the sub-pixel formation portion is activated or not; and
a predetermined capacitance connected to the data signal line via the switching element,
the data signal line drive circuit sequentially applies a data signal to express a sub-pixel to be formed by a sub-pixel formation portion connected to each data signal line, to the data signal line, and
the scanning signal line drive circuit activates a scanning signal line connected to each sub-pixel formation portion during a main charge period as a period when the sub-pixel formation portion should take in a data signal expressing a sub-pixel to be formed by the sub-pixel formation portion, and activates the scanning signal line during a preliminary charge period as a predetermined period prior to and close to the main charge period.

6. The display device according to claim 3, wherein
the data signal line drive circuit
inverts a polarity of a data signal taken into each sub-pixel formation portion in each one frame period, and
in one frame period, sets polarities of data signals taken into sub-pixel formation portions mutually adjacent in the second direction mutually the same, and inverts polarities of data signals taken into the sub-pixel formation portions in each predetermined number of sub-pixel formation portion strings extending in the second direction.

7. The display device according to claim 3, wherein
the data signal line drive circuit
inverts a polarity of a data signal taken into each sub-pixel formation portion in each one frame period, and
in one frame period, mutually differentiates polarities of data signals taken into sub-pixel formation portions mutually adjacent in the first direction, and mutually differentiates polarities of data signals taken into the sub-pixel formation portions mutually adjacent in the second direction.

8. The display device according to claim 3, wherein
the data signal line drive circuit
inverts a polarity of a data signal taken into each sub-pixel formation portion in each one frame period, and
in one frame period, sets polarities of data signals taken into sub-pixel formation portions mutually adjacent in the first direction mutually the same, and inverts polarities of data signals taken into the sub-pixel formation portions in each predetermined number of sub-pixel formation portion strings extending in the first direction.

9. The display device according to claim 8, wherein
the data signal line drive circuit
in one frame period, sets polarities of data signals taken into sub-pixel formation portions connected to the same data signal line mutually the same, and inverts polarities of data signals taken into the sub-pixel formation portions in each two sub-pixel formation portion strings corresponding to the same data signal line and extending in the first direction.

10. The display panel according to claim 1, wherein
each sub-pixel formation portion includes a switching element to come into an on state or an off state depending on whether a scanning signal line connected to the sub-pixel formation portion is activated or not, and
the switching element is a thin-film transistor formed of amorphous silicon.

11. The display panel according to claim 1, wherein
each sub-pixel formation portion includes a switching element to come into an on state or an off state depending on whether a scanning signal line connected to the sub-pixel formation portion is activated or not, and
the switching element is a thin-film transistor formed of polysilicon.

12. The display panel according to claim 1, wherein
each sub-pixel formation portion includes a switching element to come into an on state or an off state depending on whether a scanning signal line connected to the sub-pixel formation portion is activated or not, and
the switching element is a thin-film transistor formed of microcrystalline silicon.

13. The display panel according to claim 1, wherein
each sub-pixel formation portion includes a switching element to come into an on state or an off state depending on whether a scanning signal line connected to the sub-pixel formation portion is activated or not, and
the switching element is a thin-film transistor formed of indium gallium zinc oxide.

14. A method of driving a display device including a display panel including a plurality of data signal lines extending in a first direction, a plurality of scanning signal lines extending in a second direction and crossing the plurality of data signal lines, and a plurality of pixel formation portions arranged in a matrix form along the plurality of data signal lines and the plurality of scanning signal lines, and displaying a color image based on a predetermined number of primary colors, the method comprising:
a data signal line drive step of applying a plurality of data signals expressing the color image to the plurality of data signal lines respectively; and
a scanning signal line drive step of selectively activating the plurality of scanning signal lines, wherein
each pixel formation portion is configured to arrange in the first direction a predetermined number of sub-pixel formation portions for forming sub-pixels respectively expressing the predetermined number of primary colors,
each data signal line corresponds to one of a plurality of sets of sub-pixel formation portion strings obtained by dividing sub-pixel formation portions in the plurality of pixel formation portions into sets by using mutually adjacent two sub-pixel formation portion strings extending in the first direction as one set, is arranged between two sub-pixel formation portion strings constituting a corresponding set, and is connected to each sub-pixel formation portion included in the two sub-pixel formation portion strings,
each sub-pixel formation portion string extending in the second direction corresponds to one of a plurality of sets of scanning signal lines obtained by dividing the plurality of scanning signal lines into sets by using adjacent two scanning signal lines as one set, and is arranged between two scanning signal lines constituting a corresponding set,
one of two scanning signal lines constituting each set of the plurality of sets of scanning signal lines is connected to one of two sub-pixel formation portions that are connected to the same data signal line of sub-pixel formation portions included in a sub-pixel formation portion string corresponding to the set, and the other of the two scanning signal lines is connected to the other of the two sub-pixel formation portions, and
each sub-pixel formation portion takes in a data signal applied to a data signal line connected to the sub-pixel formation portion, when a scanning signal line connected to the sub-pixel formation portion is activated.

15. The method of driving a display device according to claim 14, wherein
in the scanning signal line drive step, the plurality of scanning signal lines are sequentially activated, and
in the data signal line drive step, data signals expressing sub-pixels to be formed by sub-pixel formation portions included in one of corresponding two sub-pixel formation portion strings and data signals expressing sub-pixels to be formed by sub-pixel formation portions included in the other of the corresponding two sub-pixel formation portion strings are alternately applied to each data signal line in conjunction with activation of the plurality of scanning signal lines.
